(19) United States
(12) Patent Application Publication
(10) Pub. No.: US 2026/0333338 A1
(43) Pub. Date: Oct. 22, 2026

(54) DRIFT COMPENSATION OF CONFIGURED SCHEDULING

(71) Applicant: Nokia Technologies Oy, Espoo (FI)

(72) Inventors: Zexian LI, Espoo (FI); Stefano PARIS, Massy (FR); Klaus Ingemann PEDERSEN, Aalborg (DK)

(21) Appl. No.: 19/103,476

(22) PCT Filed: Aug. 14, 2023
(86) PCT No.: PCT/IB2023/058172

§ 371 Date: Feb. 12, 2025

(30) Foreign Application Priority Data
Aug. 12, 2022 (FI) 20225717

(51) Int. Cl. H04W 72/11; H04W 72/0446

(52) U.S. Cl. CPC H04W 72/11; H04W 72/0446

(57) ABSTRACT

Systems, methods, apparatuses, and computer program products for extended reality use cases by introducing optimized semi-persistent scheduling configuration or configured grant configuration schemes. One method may include receiving, from a network entity, at least one adaptive semi-persistent scheduling configuration or configured grant configuration; receiving, from the network entity, an indication to trigger a semi-persistent scheduling or configured grant alignment; and adding or removing drift to a semi-persistent scheduling starting subframe and slot or configured grant starting subframe and slot. The semi-persistent scheduling or configured grant alignment is associated with the at least one adaptive semi-persistent scheduling configuration or configured grant configuration.

### TECHNICAL FIELD

Some example embodiments may generally relate to mobile or wireless telecommunication systems, such as Third Generation Partnership Project (3GPP) Long Term Evolution (LTE), fifth generation (5G) radio access technology (RAT), new radio (NR) access technology, sixth generation (6G), and/or other communications systems. For example, certain example embodiments may relate to systems and/or methods for improving radio resource allocation methods for extended reality (XR) use cases by introducing optimized semi-persistent scheduling/configured grant (SPS/CG) schemes.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE or base station as a generic term) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, from a network entity, at least one adaptive semi-persistent scheduling configuration or configured grant configuration. The method may further include receiving, from the network entity, an indication to trigger a semi-persistent scheduling or configured grant alignment. The semi-persistent scheduling or configured grant alignment may be associated with the at least one adaptive semi-persistent scheduling configuration or configured grant configuration. The method may further include adding or removing drift to a semi-persistent scheduling or configured grant starting subframe and slot, responsive to the indication and in accordance with the adaptive configuration.

In accordance with certain example embodiments, an apparatus may include means for receiving, from a network entity, at least one adaptive semi-persistent scheduling configuration or configured grant configuration. The apparatus may further include means for receiving, from the network entity, an indication to trigger a semi-persistent scheduling or configured grant alignment. The semi-persistent scheduling or configured grant alignment may be associated with the at least one adaptive semi-persistent scheduling configuration or configured grant configuration. The apparatus may further include means for adding or removing drift to a semi-persistent scheduling or configured grant starting subframe and slot, responsive to the indication and in accordance with the adaptive configuration.

In accordance with various example embodiments, a non-transitory computer readable medium comprising program instructions that, when executed by an apparatus, cause the apparatus to perform at least a method. The method may include receiving, from a network entity, at least one adaptive semi-persistent scheduling configuration or configured grant configuration. The method may further include receiving, from the network entity, an indication to trigger a semi-persistent scheduling or configured grant alignment. The semi-persistent scheduling or configured grant alignment may be associated with the at least one adaptive semi-persistent scheduling configuration or configured grant configuration. The method may further include adding or removing drift to a semi-persistent scheduling or configured grant starting subframe and slot, responsive to the indication and in accordance with the adaptive configuration.

In accordance with some example embodiments, a computer program product may perform a method. The method may include receiving, from a network entity, at least one adaptive semi-persistent scheduling configuration or configured grant configuration. The method may further include receiving, from the network entity, an indication to trigger a semi-persistent scheduling or configured grant alignment. The semi-persistent scheduling or configured grant alignment may be associated with the at least one adaptive semi-persistent scheduling configuration or configured grant configuration. The method may further include adding or removing drift to a semi-persistent scheduling or configured grant starting subframe and slot, responsive to the indication and in accordance with the adaptive configuration.

In accordance with certain example embodiments, an apparatus may include at least one processor and at least one memory storing instructions that, when executed by the at least one processor, cause the apparatus at least to receive, from a network entity, at least one adaptive semi-persistent scheduling configuration or configured grant configuration. The at least one memory and instructions, when executed by the at least one processor, may further cause the apparatus at least to receive, from the network entity, an indication to trigger a semi-persistent scheduling or configured grant alignment. The semi-persistent scheduling or configured grant alignment may be associated with the at least one adaptive semi-persistent scheduling configuration or configured grant configuration. The at least one memory and instructions, when executed by the at least one processor, may further cause the apparatus at least to add or remove drift to a semi-persistent scheduling or configured grant starting subframe and slot, responsive to the indication and in accordance with the adaptive configuration.

In accordance with various example embodiments, an apparatus may include circuitry configured to perform receiving, from a network entity, at least one adaptive semi-persistent scheduling configuration or configured grant configuration. The apparatus may further include circuitry configured to perform receiving, from the network entity, an indication to trigger a semi-persistent scheduling or configured grant alignment. The semi-persistent scheduling or configured grant alignment may be associated with the at least one adaptive semi-persistent scheduling configuration or configured grant configuration. The apparatus may further include circuitry configured to perform adding or removing drift to a semi-persistent scheduling or configured grant starting subframe and slot, responsive to the indication and in accordance with the adaptive configuration.

In accordance with some example embodiments, a method may include configuring a user equipment with at least one adaptive semi-persistent scheduling configuration or configured grant configuration to a user equipment. The method may further include transmitting, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

In accordance with certain example embodiments, an apparatus may include means for configuring a user equipment with at least one adaptive semi-persistent scheduling configuration or configured grant configuration to a user equipment. The apparatus may further include means for transmitting, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

In accordance with various example embodiments, a non-transitory computer readable medium comprising program instructions that, when executed by an apparatus, cause the apparatus to perform at least a method. The method may include configuring a user equipment with at least one adaptive semi-persistent scheduling configuration or configured grant configuration to a user equipment. The method may further include transmitting, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

In accordance with some example embodiments, a computer program product may perform a method. The method may include configuring a user equipment with at least one adaptive semi-persistent scheduling configuration or configured grant configuration to a user equipment. The method may further include transmitting, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

In accordance with certain example embodiments, an apparatus may include at least one processor and at least one memory storing instructions that, when executed by the at least one processor, cause the apparatus at least to configure a user equipment with at least one adaptive semi-persistent scheduling configuration or configured grant configuration to a user equipment. The at least one memory and instructions, when executed by the at least one processor, may further cause the apparatus at least to transmit, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

In accordance with various example embodiments, an apparatus may include circuitry configured to perform configuring a user equipment with at least one adaptive semi-persistent scheduling configuration or configured grant configuration to a user equipment. The apparatus may further include function circuitry configured to perform transmitting, to the user equipment, an indication to trigger a semi-persistent scheduling or configured grant alignment to the user equipment. The semi-persistent scheduling or configured grant alignment may be associated with the at least one adaptive semi-persistent scheduling configuration or configured grant configuration.

### BRIEF DESCRIPTION OF THE DRAWINGS

For a proper understanding of example embodiments, reference should be made to the accompanying drawings, wherein:

FIG. 1 illustrates an example of SPS or CG configurations for different combinations of frame-rate (periodicity), quality (class), and frame type (multi-modality).

FIG. 2 illustrates an example of desynchronization.

FIG. 3 illustrates an example of drift for the two SPS configurations as a function of the timeslot.

FIG. 4 illustrates an example of time drift for different extended reality (XR) frame rates and SPS configurations.

FIG. 5 illustrates an example of a traffic pattern of XR video stream.

FIG. 6 illustrates an example of a signaling diagram for configuration and realignment of SPS cycle with XR frame arrival for DL transmission according to certain example embodiments.

FIG. 7 illustrates an example of a signaling diagram for configuration and realignment of CG cycle with XR frame arrival for uplink (UL) transmission according to certain example embodiments.

FIG. 8 illustrates an example of a flow diagram of a method according to various example embodiments.

FIG. 9 illustrates an example of a flow diagram of a method according to various example embodiments.

FIG. 10 illustrates an example of a flow diagram of another method according to certain example embodiments.

FIG. 11 illustrates an example of a flow diagram of another method according to some example embodiments.

FIG. 12 illustrates an example of a flow diagram of another method according to various example embodiments.

FIG. 13 illustrates an example of various network devices according to some example embodiments.

FIG. 14 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for improving radio resource allocation methods for XR use cases by introducing optimized SPS/CG schemes is not intended to limit the scope of certain example embodiments, but is instead representative of selected example embodiments.

3GPP working groups system aspect (SA)4 and radio access network (RAN)1 have adopted a quasi-periodic, multimodal, and multi-class traffic model for XR applications. Specifically, XR traffic exhibits a bursty pattern with high data rate, and typically two burst types/classes that may be classified by their size. Traffic periodicity may be due to a 3D video generation process that may create a sequence of frames at a given sampling rate. For example, sampling rates may be 30, 60, 90, and 120 frames per second (fps) or cycles per second (Hz). Compression techniques used to reduce the bitrate may generate multiple types of frames that can be classified according to their size distribution. Compression can be achieved using both intra-frame and inter-frame coding. Specifically, intra-frame coding may use lossy coding techniques that only require the information carried in the compressed frame for decoding. In contrast, inter-frame coding may apply differential techniques on multiple frames to encode and transmit only the differences across consecutive frames. Frames generated using intra-frame coding may be referred to as “I-frames,” while frames generated using inter-frame coding may be referred to as “P-frames” or “B-frames,” depending on which differential technique is used. Inter-frame coding may provide higher compression (up to 5 and 10 times for P and B frames, respectively) at the cost of creating dependencies across frames. Therefore, compression techniques may generate a multimodal distribution of the frame size due to the superposition of different types of XR frames, each with its own distribution.

Similarly, rate adaptation implemented at the application layer may generate multiple classes of bursts. For example, the XR application may dynamically adjust the bitrate according to the status of the network and viewport information of the user (e.g., orientation of user's view). For example, an XR application may respond to the decrease of the end-to-end connection speed by reducing the quality of the 3D video stream and/or decreasing the frame rate. This may result in a decrease of the 3D media content carried by all different frames.

SPS may offer a reduction in overhead as compared to sending DL dynamic scheduling grants (e.g., reduced physical downlink control channel (PDCCH) overhead). In addition to the lower PDCCH overhead, SPS may offload the computational burden from a dynamic gNB medium access control (MAC) scheduler. 3GPP NR Rel-16 introduced several DL SPS enhancements to support URLLC and time sensitive communication (TSC) transmission of small payloads. However, SPS is not well suited for XR use cases; for example, SPS is a method where DL radio resources for sending one transport block with a regular time-periodicity is configured for a UE. Up to eight simultaneous active SPS configurations may be configured for a UE (configured via radio resource control (RRC) signaling), with periodicity of any integer of a slot (N*14), and minimum periodicity in Rel-15 of 10 ms. DL SPS also relies on separate configuration (RRC-based) and activation/deactivation (PDCCH addressed to configured scheduling radio network temporary identifier (CS-RNTI) can either signal and activate the configured DL assignment or deactivate it). Similarly, semi-persistent resource allocation in UL may specify CGs.

SPS/CG currently only allows the definition of a static integer period for the radio resources allocated to a certain UE. The integer periodicity may be specified with subframe (SF) or slot or sub-slot granularity depending on the RRC configuration. The non-integer periodicity of XR traffic (e.g., XR traffic with periodicity of 16.67 ms which is not aligned with 5G numerology) may result in a time drift between the starting slot (or subframe) of the SPS period and the periodic arrival of XR traffic. For DL, time drift accumulate may over time as XR traffic drifts apart from SPS, and eventually result in desynchronization between the SPS resource period and the XR traffic. As a result, this may cause the loss of the XR frames since packet transmission may be delayed until the next configured opportunity while the packet delay budget (PDB) is usually smaller than XR traffic periodicity (e.g., PDB may be equal to 10 ms or 15 ms against 16.67 ms for XR periodicity at 60 fps).

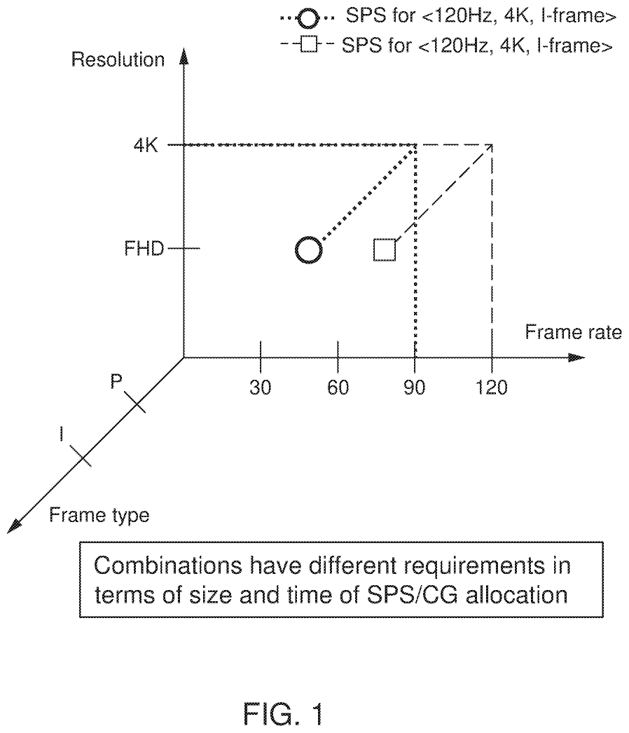

Furthermore, the multiple combinations of frame rate (periodicity), quality (resolution), and frame type (compression) that may be used by the rate adaptation algorithm of an XR application to scale the quality up or down may require multiple SPS/CG configurations that result in multiple time-drifts (e.g., at least one time drift for each pair of SPS configuration and XR frame rate). For example, in a scenario with 4 frame rates (e.g., 30, 60, 90, and 120 Hz), two resolution qualities (e.g., Full HD and 4K) and two frame types (e.g., I-frame and P-frame), 16 combinations may be possible corresponding to 16 dedicated SPS configurations, in particular, a dedicated period and a number of time-frequency resources (i.e., number of consecutive TTIs and PRBs) for each combination, as illustrated in FIG. 1. The period of these 16 combinations, however, may not perfectly match the period of the combination, thus potentially resulting in 16 time drifts. Therefore, compensating for a single time drift is insufficient since properties such as magnitude, sign, and derivate may depend on the XR class and active SPS/CG configuration.

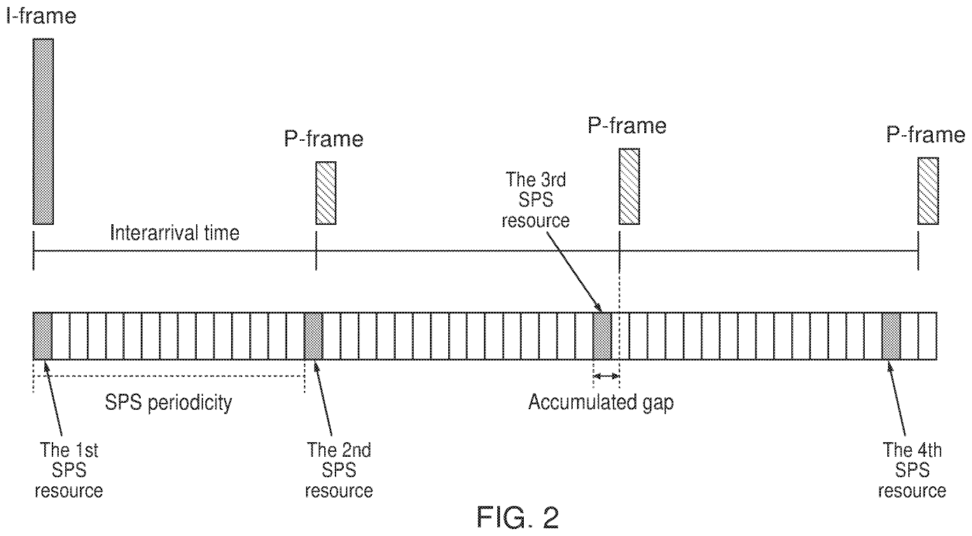

As an example, a typical frame rate of an XR application may be 60 fps, which may correspond to an average interarrival time (or periodicity) of video frames equal to 16.67 ms. Subcarrier spacing (SCS) may be 15 kHz, and the network may have a configured periodicity for DL SPS equal to 16 ms using periodicityExt in SPS-Config (e.g., 16 slots). Every 16 ms, the base station may schedule dedicated radio resources for a certain UE running a XR service. As shown in FIG. 2 and Table 1 (below), after 2 cycles, the XR packet arrival time and the SPS resource period may become desynchronized by 1 ms. More specifically, when the SPS scheduling opportunity is ready for the UE, the packet may miss the DL granted resource since it has not arrived yet.

The top portion of FIG. 2 illustrates XR frame arrivals, while the bottom portion illustrates subframes and SPS scheduling opportunities (solid blocks). The gap between integer periodicity of SPS cycle and non-integer periodicity of XR frames may accumulate over time. Thus, the SPS cycle may drift apart from the frame arrival. In case of 60 fps and SPS periodicity of 16 ms, the third frame (i.e., the second P-frame) may miss the configured scheduling opportunity. The base station may detect this mismatch, and attempt to use dynamic scheduling for the XR packet. The possibility to serve the packet may depend on the load (note that XR services may have heavy traffic requirements and the network may become quickly saturated). The base station may also trigger a RRC reconfiguration, but frequent reconfiguration may become necessary to resynchronize the SPS cycle with the XR periodicity. RRC reconfiguration may introduce extra-delay and heavy signaling overhead in the transmission.

| | XR | SPS 1 | SPS 2 | Drift of | Drift of |
|---|---|---|---|---|---|
| | packet | (16 ms) | (17 ms) | SPS 1 | SPS 2 |
| Cycle | arrival | slot | slot | (16 ms) | (17 ms) |
| 0 | 0 | 0 | 0 | 0 | 0 |
| 1 | 16.67 | 16 | 17 | 0.67 | −0.33 |
| 2 | 33.34 | 32 | 34 | 1.34 | −0.66 |
| 3 | 50.01 | 48 | 51 | 2.01 | −0.99 |
| 4 | 66.68 | 64 | 68 | 2.68 | −1.32 |
| 5 | 83.35 | 80 | 85 | 3.35 | −1.65 |
| 6 | 100.02 | 96 | 102 | 4.02 | −1.98 |
| 7 | 116.69 | 112 | 119 | 4.69 | −2.31 |
| 8 | 133.36 | 128 | 136 | 5.36 | −2.64 |
| 9 | 150.03 | 144 | 153 | 6.03 | −2.97 |
| 10 | 166.7 | 160 | 170 | 6.7 | −3.3 |
| 31 | 516.77 | 496 | 527 | 20.77 | −10.23 |

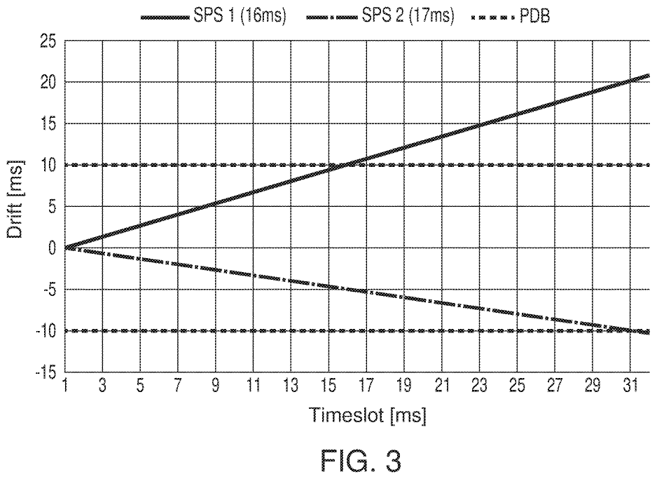

FIG. 3 depicts changes in time drift of the two SPS configurations with periodicity of 16 ms and 17 ms, respectively. Positive drift between XR and SPS may correspond to XR frame arriving late with respect to scheduling grant, whereas negative drift between XR and SPS may correspond to XR frame arriving early with respect to scheduling grant. We can observe that the gap keeps accumulating. Using configuration SPS 1 after the second SPS cycle, the XR frame may be late and miss the scheduling opportunity (see Table 1 above). In contrast, with configuration SPS 2, the XR frame may arrive earlier than the scheduling opportunity so the frame may be transmitted when the SPS allocation becomes available. However, after 31 cycles, XR frames may become delayed beyond their PDB (31×(17-16.67)≈10 ms). As a result, time drift may cause 3.3% and 6.25% (i.e., 1/16 and 1/30) frame errors with SPS 1 and SPS 2 configurations, respectively. However, XR traffic may require 99% of frames to be delivered within their PDB.

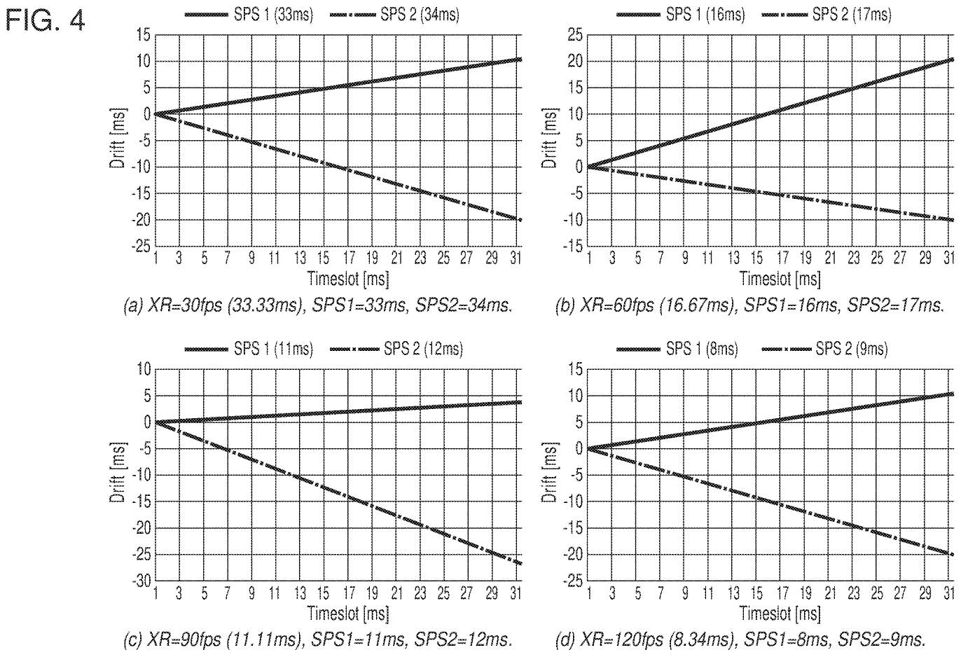

Time drifts for typical values of XR frame rate and integer periodicities of SPS configuration are illustrated in FIG. 4, where the drift resulting from the difference between the integer SPS periodicity and non-integer XR periodicity accumulates. Positive drift refers to the XR frame arriving on late with respect to the scheduling grant, thus forcing the scheduler to postpone the transmission to the next grant or handling it with dynamic scheduling. SPS with negative drift may start losing frames when drift approaches the PDB (10 ms in case of AR/VR services) minus the frame transmission latency.

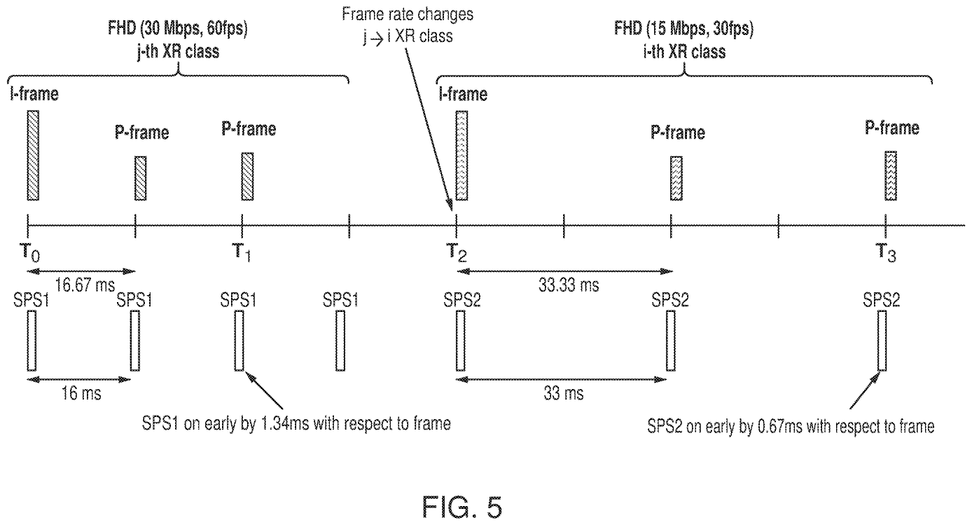

FIG. 5 shows that SPS/CG reconfiguration does not resolve challenges with time drift. FIG. 5 illustrates a sequence of frames generated by XR application with framerate change and SPS reconfiguration. At time T2, the XR application downscales the framerate from 60 fps to 30 fps (time T1 corresponds to the instant of the last frame arrival generated with frame rate 60 fps). The frame rate downscaling results in an increase of the interarrival time between consecutive frames that trigger the reconfiguration of the SPS allocation either through RRC reconfiguration or with other schemes. However, the time-drift due to the mismatch of integer and non-integer periodicity keeps accumulating even if the reconfiguration at time T2 has realigned the XR traffic with the new SPS configuration. As illustrated in FIG. 5, even the reconfiguration has realigned SPS and XR traffic at time T2, the third frame generated at 30 fps arrives at time T3 on late by 0.67 ms with respect to the SPS scheduling grant.

Certain example embodiments described herein may have various benefits and/or advantages to overcome the disadvantages described above. For example, certain example embodiments may enable fast correction of only SPS/CG resources when drift becomes too large, covers variable drift due to, for example, a change of XR frame rate, and provide solutions both for DL SPS and UL CG.

Some example embodiments may provide a simple and efficient scheme to solve time drift due to periodicity mismatch between SPS/CG configuration and XR traffic, and may apply beyond XR traffic, namely applications with periodicity mismatch between SPS/CG and traffic arrival process. Furthermore, various example embodiments may allow requirements of XR traffic to be satisfied even if SPS/CG and XR periods does not match perfectly, and include multiple embodiments with different signaling overhead for the realignment procedure. This includes multiple XR application scenarios with different properties for frame rate like fixed and dynamic frame rate, XR resolution adaptation, periodic and quasi-periodic traffic. Thus, certain example embodiments discussed below are directed to improvements in computer-related technology.

Various example embodiments discussed herein may compensate for time drift between configured resources, such as SPS/CG and XR traffic. The drift may be caused by, for example, the periodicity mismatch between a CG and the XR traffic. If the drift grows too large, it may cause the loss or delay of packets. Proposed herein are techniques to decide “when” and “how much” to compensate the drift between several XR classes and SPS/CG configurations. In particular, certain embodiments may include autonomous compensation, where both the UE and the network may apply an offset to the SPS/CG allocation every predetermined time period, such as parameter PeriodicitySyncCycle. As another example embodiment, when the network and/or UE is triggered, in DL, the network may signal an offset to the UE when the drift becomes larger than a threshold, such as a parameter PeriodicitySyncTh. Both the UE and the network apply the offset signaled by the network. In UL, the UE may request the network to compensate for the drift when the drift becomes larger than the threshold, (e.g., PeriodicitySyncTh). The network may then decide the amount of the offset, and subsequently notify the UE. Both the UE and the network may then apply the signaled offset. The network may then autonomously decide to compensate the drift, and signal the offset to the UE. Both the UE and the network may then apply the signaled offset.

As used in some embodiments herein, “drift” may refer to the accumulated time offset between the SPS/CG resources and an XR frame. For example, “adding drift” may be used for SPS/CG resources selection, wherein a later subframe may be selected as a new start subframe of the allocated SPS/CG resource in order to achieve the alignment between an arrival time of XR frame and a starting subframe of the SPS/CG resource. Similarly, “removing drift” may also be used for SPS/CG resources selection, wherein an earlier subframe may be selected as a new start subframe of the allocated SPS/CG resource in order to achieve the alignment between an arrival time of XR frame and a starting subframe of the SPS/CG resource.

Some example embodiments described below may include enhancements to the configuration of the SPS and CG resource allocation to align the SPS/CG resource allocation pattern in line with the drift of the XR traffic pattern at the RAN. This adaptation may use an extension of an information element (IE) configuration exchanged through RRC configuration messages. In addition, various example embodiments may include enhancements to control messages exchanged between the base station and UE in order to dynamically adapt SPS/CG cycles according to traffic pattern and/or UE status. This may be achieved by defining a new control command to shift the next SPS/CG cycle by a certain offset, and may be (carried by, for example, MAC control element (MAC CE) or downlink control information (DCI)).

Furthermore, various embodiments may include a design of a scheme to track drift between SPS/CG and XR traffic classes, and to decide when to compensate the drift without signaling. The UE and base station may compute the drift and when to compensate the drift, and use the definition of new behavior in the standard to keep network and UE aligned. As an example, tracking and compensation of drift may be based on multiple pairs of threshold <PeriodicitySyncCycle, PeriodicitySyncTh> (one for each XR class-SPS configuration) to determine when to compensate for drift (i.e., how much and when to compensate). Since a single pair of thresholds may not account for all time drift, new UE behavior may be defined to use those thresholds and signaling scheme to enforce ad-hoc compensation.

As illustrated in FIG. 2, the mismatch between the non-integer periodicity of XR frame generation and integer SPS/CG cycle defined by SPS/CG parameters may result in the loss or delay of XR frames. In particular, let t∈{0, 1, 2, 3, . . . } be the sequence number that identifies the SPS cycle, Tₖ^{SPS}∈N be the integer duration of SPS period of the k^{th} SPS configuration (e.g., periodicity field of SPS-Config), Tᵢ^{XR}∈N be the non-integer periodicity of frames of the i^{th} XR class, δᵢ∈R be the difference between SPS cycle and XR periodicity of the i^{th} XR class, and Δᵢ(t) be the time drift of the i^{th} XR class. Time drift may be set to zero at the beginning if the traffic is aligned with the SPS configuration: ∀i, Δᵢ(t)=0. The number of SPS configurations may be the same as the number of XR classes and i=k. If the number of SPS/CG configurations is smaller than the number of XR classes (for example, due to the assignment of a SPS/CG configuration to multiple XR classes), the assumption that the number of SPS/CG configurations is the same as the number of XR classes (i.e., i=k) may be relaxed by replicating any SPS/CG configuration that has been assigned to multiple XR classes. The drift of 2 subframes may be added to the 4^{th} SPS resource, then the 4^{th} SPS resource can be aligned with the starting of the P-frame.

Some example embodiments may use tⱼᵢ∈{0, 1, 2, 3, . . . } to denote the SPS cycle when the XR traffic change from j class to i^{th} class (for example, when the frame rate changes from j=30 to i=60 fps). If the configured resource is aligned with the first packet at the beginning, the time drift for the i^{th} XR class may change according to:

Δᵢ(t)=Δⱼ(t−1)+δₖᵢt=tⱼᵢΔᵢ(t)=Δᵢ(t−1)+δₖᵢt>tⱼᵢ (1)

where

δₖᵢ=Tₖ^{SPS}−Tᵢ^{XR}. (2)

The formula in equations (1) and (2) for the computation of the drift may be used for both UL and DL if both entities know the XR class and SPS/CG configuration. In the case of one SPS/CG configuration for one XR class (that is, i=k), this may be insignificant since the active SPS/CG configuration may also indicate the XR class, and the difference between the XR and SPS/CG periods in equation (2) (i.e, δ_ii) can be indicated as a parameter. In some embodiments described below, one SPS/CG configuration is assigned to one XR class, and a single index “i” may be used to identify both. If multiple XR classes are assigned to the same SPS/CG configuration, the difference between each XR and SPS/CG periods in equation (2) (i.e, δ_ki) may be provided during the configuration. In various example embodiments, the network (for DL) or the UE (for UL) may estimate and indicate to the other entity the amount of the drift.

To compensate for the time drift, the UE may be informed of the periodicity mismatch, and when to anticipate or postpone the beginning of the next SPS/CG cycle (or equivalently, the end of the current SPS/CG cycle). The following SPS/CG parameters may be specified for each SPS/CG configuration, for example, in the SPS-Config IE (index “i” indicates the i^{th} SPS/CG configuration and i^{th} XR class):
PeriodicityDrift (|δᵢ|): a drift parameter obtained as absolute value defined in equation (2).
PeriodicityDriftSign (sign(δᵢ)): indicates the sign of the drift (for example, one bit).
PeriodicitySyncCycle (Pᵢ^{C}): indicates the number of SPS/CG cycles before compensating the drift in the next SPS/CG cycle (for example, anticipating or postponing the start of the next SPS/CG cycle). This threshold may be used by the network and the UE as a default realignment period.
PeriodicitySyncTh (Pᵢ^{T}): a threshold for the drift amount that triggers the realignment procedure. The drift compensation procedure may be initiated by the network with the transmission of a dedicated command; however, for UL transmission, the realignment procedure may also be initiated by the UE by sending a request for realignment of CG cycle and traffic.

Depending on the implementation, PeriodicityDrift and PeriodicityDriftSign can be merged into one parameter as well.

The pair of thresholds PeriodicitySyncCycle and PeriodicitySyncTh may be determined based on (i) the difference between the XR traffic class and SPS/CG periods (that is, the difference computed in equation (2)), (ii) how much drift the SPS/CG allocation can tolerate before the XR expected arrival falls outside the SPS/CG allocation, and/or (iii) the maximum frequency of drift compensation (that is, how many times the drift is compensated during a certain time interval). Factors (i) and (ii) may depend on the XR application, while (iii) may be a choice of the network operator. However, the maximum frequency may be bounded depending on the drift and tolerance before the XR frames falls outside the SPS/CG allocation. In some example embodiments, the two thresholds may be computed where δᵢ=Tᵢ^{SPS}−Tᵢ^{XR} is the drift, Dᵢ^{T} is how much drift the SPS/CG allocation can tolerate before the XR expected arrival falls outside the SPS/CG allocation, and FT is the maximum frequency of drift compensation measured in terms of SPS/CG cycles before compensation procedure takes place. Thresholds PeriodicitySyncCycle and PeriodicitySyncThbe may be computed by solving the following linear system of equations:

$${P}_{i}^{C} \leq {F}_{i}^{T}$$

$${P}_{i}^{T} \leq {D}_{i}^{T}$$

$${δ}_{i} \cdot {P}_{i}^{C} \leq {P}_{i}^{T} ,$$

which can be solved by first fixing

$${P}_{i}^{T} = {D}_{i}^{T} ,$$

and then computing

$${P}_{i}^{C} = min \{ \frac{{P}_{i}^{T}}{{δ}_{i}} , {F}_{i}^{T} \} .$$

Parameters PeriodicitySyncCycle and PeriodicitySyncThbe may enable the UE and the base station to know when the timing of the SPS/CG pattern shall be adjusted, and the adjustments can be carried out in a predictive manner. In order to provide further flexibility, new control messages and procedures may be used to (i) initiate the adjustment of the SPS/CG pattern (that is, the procedure started by the network), (ii) request an adjustment of the SPS/CG pattern (that is, the request triggered by the UE and alternative to (i)), and (iii) apply the adjustment in a specific cycle (that is, the command sent by the base station). The signaling may be implemented as new L1 and/or L2 control messages.

In various example embodiments discussed herein, after a DL assignment is configured for SPS, a MAC entity may consider sequentially that the Na downlink DL occurs in the slot for which: (numberOfSlotsPerFrame×SFN+slot number in the frame) [(numberOfSlotsPerFrame×SFN_{start time}+slot_{start time}+offset_{start time})+N×(periodicity+offset_{periodicity}×numberOfSlotsPerFrame/10] modulo (1024×numberOfSlotsPerFrame), where SFN_{start time} and slot_{start time} are the SFN and slot, respectively, of the first transmission of PDSCH where the configured DL assignment was initialized or reinitialized. Offset_{start time} and offset_{periodicity} may be the offsets to be applied to the slot and period, respectively, communicated by the network with a realignment message.

After an UL grant is configured for a CG Type 1, the MAC entity may consider sequentially that the N^{th} (N>=0) UL grant occurs in the symbol for which: [(SFN×numberOfSlotsPerFrame×numberOfSymbolsPerSlot)+[(slot number in the frame offset_{start time})×numberOfSymbolsPerSlot]+symbol number in the slot+offset-symbol_{start time}]=(timeReferenceSFN×numberOfSlotsPerFrame×numberOfSymbolsPerSlot+timeDomainOffset×numberOfSymbolsPerSlot+S+N×(periodicity+offset_{periodicity}) modulo (1024×numberOfSlotsPerFrame×numberOfSymbolsPerSlot). After an UL grant is configured for a CG Type 2, the MAC entity may consider sequentially that the N^{th} (N>=0) UL grant occurs in the symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+(slot_{start time}+offset_{start time})×numberOfSymbolsPerSlot+symbol_{start time}+offset-symbol_{start time})+N×(periodicity+offset_{periodicity})] modulo (1024×numberOfSlotsPerFrame×numberOfSymbolsPerSlot). SFN_{start time}, slot_{start time}, and symbol_{start time} may correspond with the SFN, slot, and symbol, respectively, of the first transmission opportunity of physical uplink shared channel (PUSCH) where the configured UL grant was initialized or reinitialized. In the formula offset_{start time}, offset-symbol_{start time} and offset_{periodicity} may correspond with the offsets to be applied to the slot, symbol and period, respectively, communicated by the network with a realignment message.

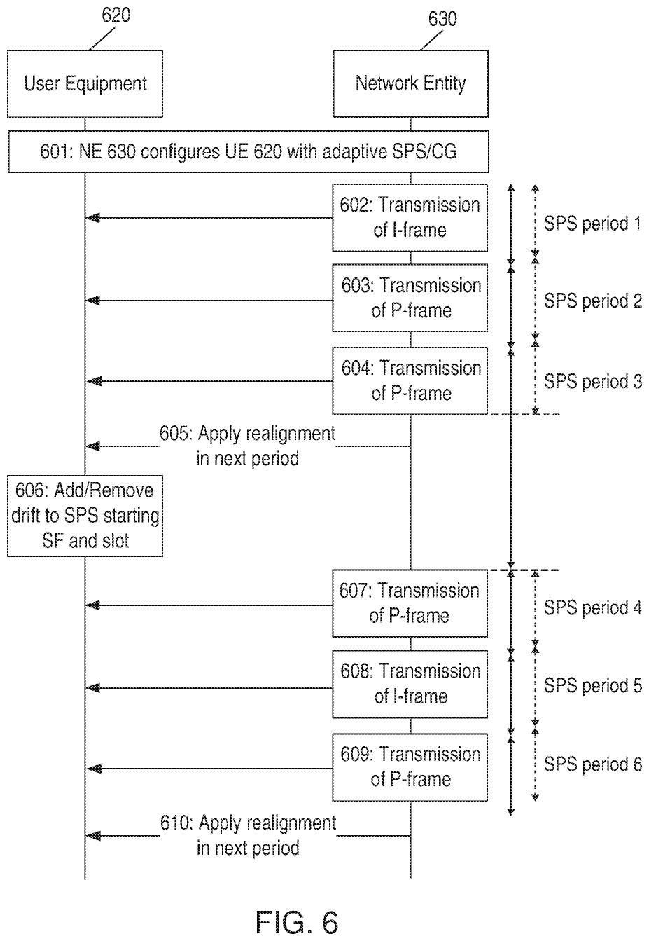

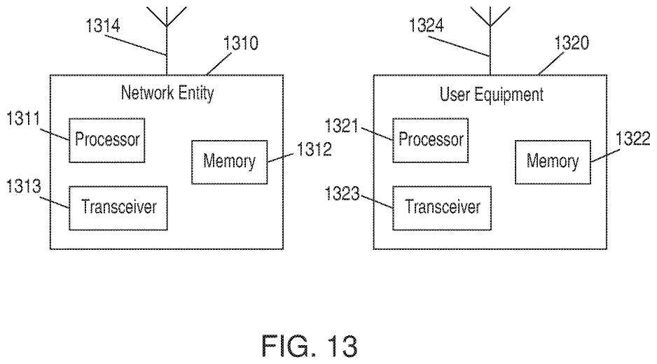

FIG. 6 illustrates an example of a signaling diagram depicting an enhanced SPS configuration for the transmission of DL traffic. UE 620 and network entity (NE) 630 may be similar to UE 1320 and NE 1310, as illustrated in FIG. 13, according to certain example embodiments. The realignment can be implemented through a control command or performed directly by NE 630 and UE 620 using the new parameters communicated during the initial configuration.

In various example embodiments, the parameters may be set as: PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 601, NE 630 may configure UE 620 with one or more of parameters PeriodicityDrift, PeriodicityDriftSign, and/or PeriodicitySyncCycle, PeriodicitySyncCycleTh, as discussed above.

At 602-604, NE 630 may transmit DL traffic to UE 620 according to currently specified SPS operations (that is, transmission is performed in the granted DL SPS resources).

At 605, when the accumulated time drift exceeds a certain threshold (for example, PeriodicitySyncCycleTh), NE 630 may inform UE 620 to apply the realignment, communicating at least which SPS cycle will be resynchronized and/or the offset to be applied to the starting slot or subframe (SF). As an example, FIG. 6 depicts this as occurring during the third and sixth SPS cycles.

At 606, UE 620 may add or remove the drift to SPS starting SF and slot.

At 607-609, NE 630 may transmit DL traffic to UE 620 according to currently specified SPS operations (that is, transmission is performed in the granted DL SPS resources).

At 610, when the accumulated time drift exceeds a certain threshold (for example, PeriodicitySyncCycleTh), NE 630 may inform UE 620 to apply the realignment, communicating at least which SPS cycle will be resynchronized and/or the offset to be applied to the starting slot or SF.

In various example embodiments, the realignment may be implemented through a control command or performed directly by NE 630 and UE 620 using the new parameters communicated during the initial configuration.

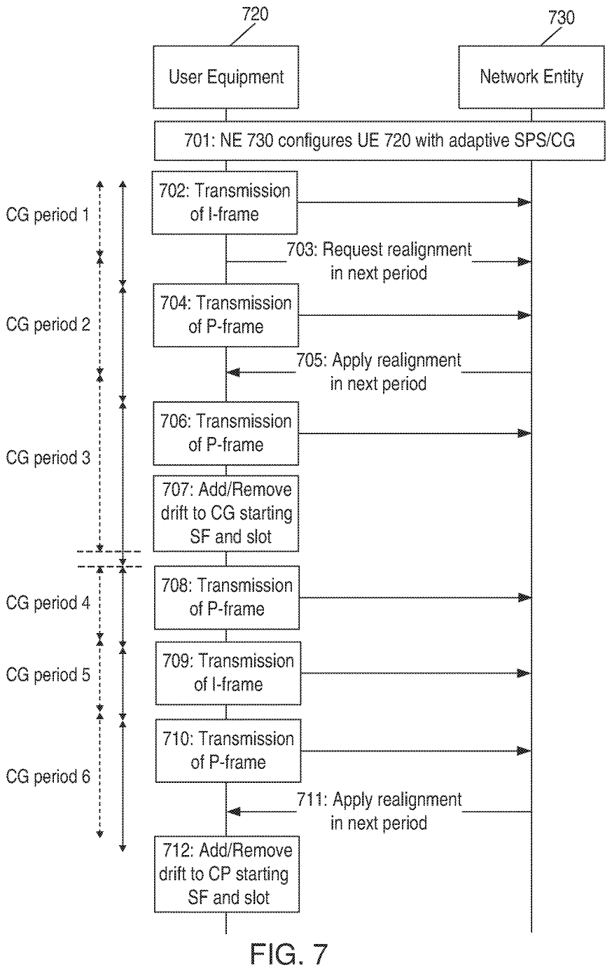

FIG. 7 illustrates an example of a signaling diagram depicting an enhanced CG configuration for UL transmissions. UE 720 and NE 730 may be similar to UE 1320 and NE 1310, as illustrated in FIG. 13, according to certain example embodiments. The realignment can be requested by UE 720 and implemented through a control command sent by NE 730 or performed directly by UE 720 and NE 730 using the new parameters communicated during the initial configuration.

In various example embodiments, the parameters may be set as: PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 701, NE 730 may configure UE 720 with one or more of parameters PeriodicityDrift, PeriodicityDriftSign, and/or PeriodicitySyncCycle, PeriodicitySyncCycleTh, as discussed above.

At 702, UE 720 may transmit UL traffic to NE 730 according to currently specified CG operations (that is, transmission is performed in the granted UL CG resources).

At 703, when the accumulated time drift exceeds the configured threshold PeriodicitySyncTh, UE 720 may transmit a request for realignment to NE 730 (message 1).

At 704, UE 720 may transmit UL traffic to NE 730 according to currently specified CG operations (that is, transmission is performed in the granted UL CG resources).

At 705, NE 730 may determine the amount of realignment (e.g., the offset) and the CG cycle to be realigned, and communicate this information to UE 720 (message 2).

At 706, UE 720 may transmit UL traffic to NE 730 according to currently specified CG operations (that is, transmission is performed in the granted UL CG resources).

At 707, UE 720 may add or remove drift to the CG starting SF and slot.

At 708-710, UE 720 may transmit UL traffic to NE 730 according to currently specified CG operations (that is, transmission is performed in the granted UL CG resources).

At 711, NE 730 may determine the amount of realignment (e.g., the offset) and the CG cycle to be realigned, and communicate this information to UE 720.

At 712, UE 720 and NE 730 may apply an offset to the starting slot and/or SF indicated by NE 730. In FIG. 7, offset is applied to CG cycles 4 and 7.

In various example embodiments, the decision on the compensation may be decided autonomously by NE 730 for the realignment decision for CG cycle 7, which is signaled in CG cycle 6. The decision may be made by NE 730 after a number of cycles PeriodicitySyncCycle from the previous re-alignment request (in the FIG. 4 CG cycles after CG cycle 3, hence in CG cycle 7). NE 730 can may decide based on other criteria; for example, if UE 720 sends a buffer status report (BSR) to transmit traffic before the CG allocation.

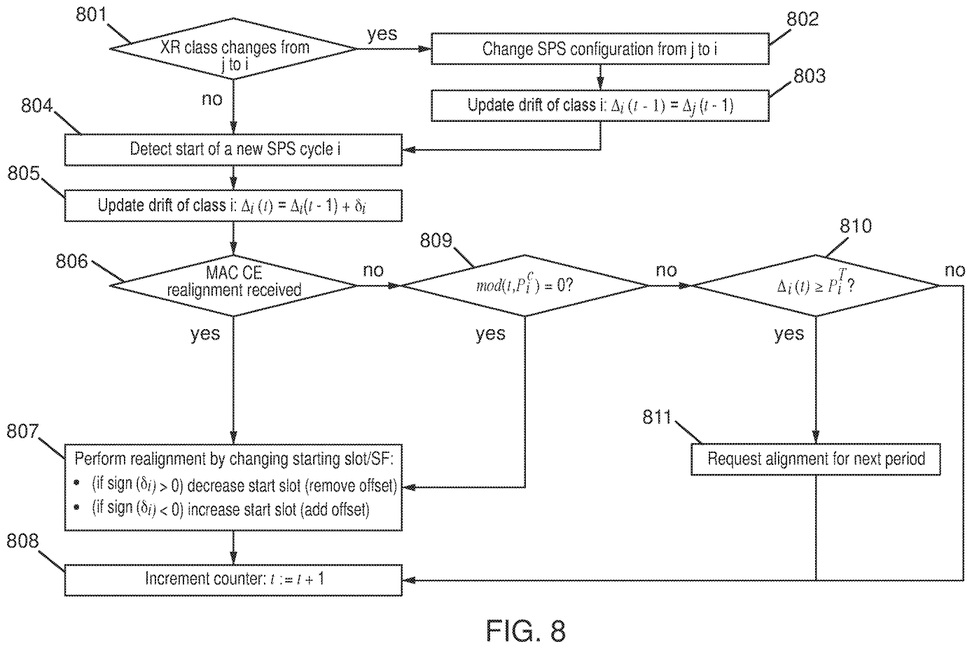

FIG. 8 illustrates an example of a flow diagram of a method that may be performed by a UE, such as UE 1320 illustrated in FIG. 13, according to various example embodiments. In particular, FIG. 8 depicts the realignment procedure implemented by the UE, where P_{C} (PeriodicitySyncCycle) is the realignment parameter used by the UE and the network by default to enforce the realignment. PT (PeriodicitySyncCycleTh) is the realignment parameter used by the UE to trigger the request of realignment. In this example, MAC CE is taken as example to carry realignment command.

At 801, the method may include determining whether XR class changes from j to i. If so, the method may include changing SPS configuration from j to i at 802, and at 803, updating drift of class Δᵢ(t−1)=Δⱼ(t−1).

At 804, the method may include detecting a start of a new SPS cycle i. At 805, the method may include updating drift of class Δᵢ(t)=Δⱼ(t−1)+δᵢ.

At 806, the method may include determining whether a MAC CE realignment has been received. If yes, at 807, the method may include performing realignment by changing starting slot and/or SF; for example, (if sign(δᵢ)>0), start slot may be decreased (remove offset), while (if sign(δᵢ)<0), start slot may be increased (add offset). At 808, an incremental counter t may be increased by 1. After receiving the alignment indication, the realignment may be applied to the SPS/CG resource right after receiving the indication.

If it is determined at 806 that a MAC CE realignment has not been received, at 809, the method may include determining whether mod(t, Pᵢ^{C})=0; if yes, the method may proceed to 807. If not, at 810, the method may include determining whether Δᵢ(t)≥Pᵢ^{T}; if so the method may include, at 811, requesting realignment for the next period, and then proceeding to 808. Identifying the first subframe may be based upon PeriodicitySyncCycle (P_{C}ⁱ), which may be used by the gNB and the UE as a default realignment period. For example, assuming PeriodicitySyncCycle=4 (i.e., the realignment occurs every 4′ SPS/CG resource) and the index of the first SPS/CG resource is 0, realignment may occur on the SPS/CG resource if mod (SPS/CG resource index, PeriodicitySyncCycle)=0 where mod represents modulo operation.

The UE and gNB may continue updating the time drift Δᵢ(t) at each SPS/CG iteration for the i^{th} XR class. Upon reception of the realignment command and/or after a certain number of iterations (parameter PeriodicitySyncCycle), the UE may increase or decrease the current SPS/CG cycle by an offset. This offset may depend on the time drift Δᵢ(t), and may be computed, for example, as offset=Δᵢ(t)=tᵢ×δ, where tᵢ measures the time instant when the i^{th} SPS configuration of the i^{th} XR class has been triggered. The time instant tᵢ can be computed as the difference between the absolute SPS iteration and the iteration when the traffic switches from j^{th} class to i-class: tᵢ=t−tⱼᵢ. Another way of computing the offset is by measuring the difference between the actual XR frame arrival and the starting slot/subframe of the dedicated SPS/CG configuration. In another embodiment, this offset can be communicated by the network. If the drift becomes larger than a certain threshold PT (PeriodicitySyncTh), then the UE may initiate the realignment procedure by sending a realignment request to the network.

In some example embodiments, once the necessary parameters, for example periodicity of XR traffic and SPS/CG resources, PeriodicitySyncCycle, are configured, the UE may be configured to execute the realignment process after a number of SPS/CG cycles equal to PeriodicitySyncCycle since the last realignment. Such behavior may be set as fallback behavior if no realignment command received.

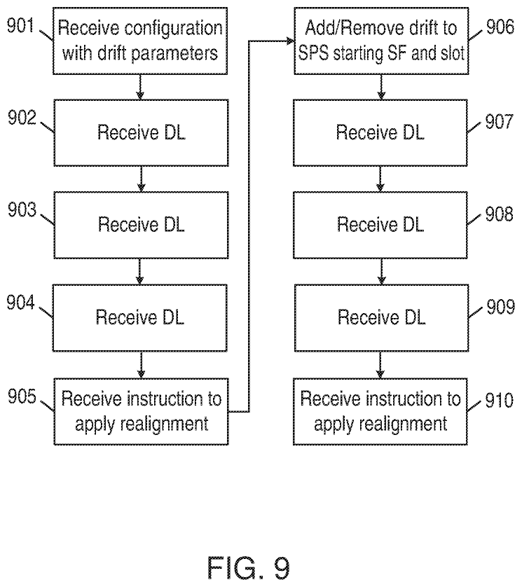

FIG. 9 illustrates an example of a flow diagram of a method that may be performed by a UE, such as UE 1320 illustrated in FIG. 13, according to various example embodiments. The realignment can be implemented through a control command or performed directly by the UE or a NE (such as NE 1310 illustrated in FIG. 13) using the new parameters communicated during the initial configuration.

In various example embodiments, the parameters may be set as PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 901, the method may include receiving a configuration from the NE with one or more of parameters PeriodicityDrift, PeriodicityDriftSign, and/or PeriodicitySyncCycle, PeriodicitySyncCycleTh, as discussed above.

At 902-904, the method may include receiving DL traffic from the NE according to currently specified SPS operations (that is, transmission is performed in the granted DL SPS resources).

At 905, when the accumulated time drift exceeds a certain threshold (for example, PeriodicitySyncCycleTh), the method may include receiving instructions from the NE to apply the realignment, and an indication of at least which SPS cycle will be resynchronized and/or the offset to be applied to the starting slot or subframe (SF). This may occur during the third and sixth SPS cycles.

At 906, the method may include adding or removing the drift to SPS starting SF and slot.

At 907-909, the method may include receiving DL traffic from the NE according to currently specified SPS operations (that is, transmission is performed in the granted DL SPS resources).

At 910, when the accumulated time drift exceeds a certain threshold (for example, PeriodicitySyncCycleTh), the method may include receiving instructions from the NE to apply the realignment, and an indication of at least which SPS cycle will be resynchronized and/or the offset to be applied to the starting slot or SF.

In various example embodiments, the realignment may be implemented through a control command or performed directly by the NE and UE using the new parameters communicated during the initial configuration.

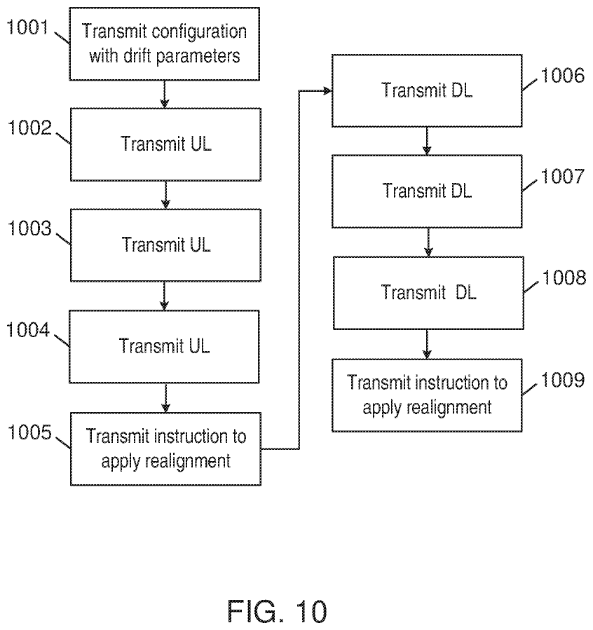

FIG. 10 illustrates an example of a flow diagram of a method that may be performed by a NE, such as NE 1310 illustrated in FIG. 13, according to various example embodiments. The realignment can be implemented through a control command or performed directly by the NE or a UE (such as UE 1320 illustrated in FIG. 13) using the new parameters communicated during the initial configuration.

In various example embodiments, the PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 1001, the method may include transmitting a configuration to the UE with one or more of parameters PeriodicityDrift, PeriodicityDriftSign, and/or PeriodicitySyncCycle, PeriodicitySyncCycleTh, as discussed above.

At 1002-1004, the method may include transmitting DL traffic to the UE according to currently specified SPS operations (that is, transmission is performed in the granted DL SPS resources).

At 1005, when the accumulated time drift exceeds a certain threshold (for example, PeriodicitySyncCycleTh), the method may include transmitting instructions to the UE to apply the realignment, communicating at least which SPS cycle will be resynchronized and/or the offset to be applied to the starting slot or subframe (SF). This may occur during the third and sixth SPS cycles.

At 1006-1008, the method may include transmitting DL traffic to the UE according to currently specified SPS operations (that is, transmission is performed in the granted DL SPS resources).

At 1009, when the accumulated time drift exceeds a certain threshold (for example, PeriodicitySyncCycleTh), the method may include transmitting instructions to the UE to apply the realignment, communicating at least which SPS cycle will be resynchronized and/or the offset to be applied to the starting slot or SF.

In various example embodiments, the realignment may be implemented through a control command or performed directly by the NE and UE using the new parameters communicated during the initial configuration.

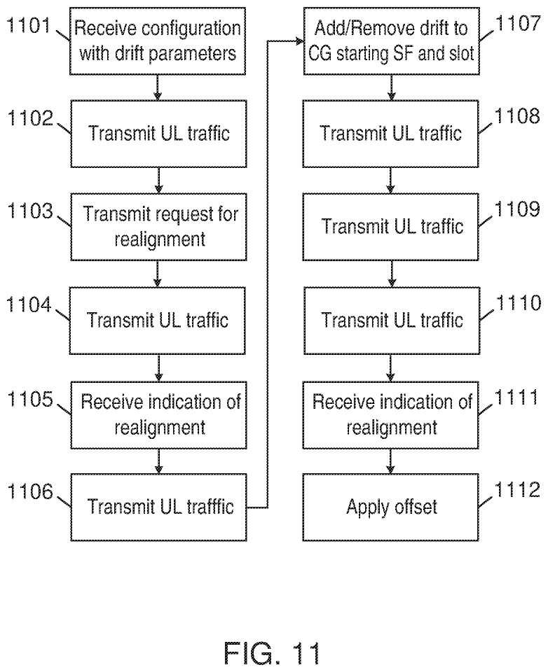

FIG. 11 illustrates an example of a flow diagram of a method that may be performed by a UE, such as UE 1320 illustrated in FIG. 13, according to various example embodiments. The realignment can be requested by the UE and implemented through a control command sent by a NE or performed directly by the UE and the NE using the new parameters communicated during the initial configuration.

In some example embodiments, PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 1101, the method may include receiving a configuration with one or more of drift parameters PeriodicityDrift, PeriodicityDriftSign, and/or PeriodicitySyncCycle, PeriodicitySyncCycleTh, as discussed above.

At 1102, the method may include transmitting UL traffic to the NE according to currently specified CG operations (that is, transmission is performed in the granted UL CG resources).

At 1103, when the accumulated time drift exceeds the configured threshold PeriodicitySyncTh, the method may include transmitting a request for realignment to the NE (message 1).

At 1104, the method may include transmitting UL traffic to the NE according to currently specified CG operations (that is, transmission is performed in the granted UL CG resources).

At 1105, the method may include receiving an indication of a determination of an amount of realignment (e.g., the offset) and the CG cycle to be realigned (message 2).

At 1106, the method may include transmitting UL traffic to the NE according to currently specified CG operations (that is, transmission is performed in the granted UL CG resources).

At 1107, the method may include adding or removing drift to the CG starting SF and slot.

At 1108-1110, the method may include transmitting UL traffic to the NE according to currently specified CG operations (that is, transmission is performed in the granted UL CG resources).

At 1111, the method may include receiving an indication of a determination of an amount of realignment (e.g., the offset) and the CG cycle to be realigned (message 2).

At 1112, the method may include applying an offset to the starting slot and/or SF indicated by the NE.

In various example embodiments, the decision on the compensation may be decided autonomously by the NE for the realignment decision for CG cycle 7, which is signaled in CG cycle 6. The decision may be made by the NE after a number of cycles PeriodicitySyncCycle from the previous re-alignment request (in the FIG. 4 CG cycles after CG cycle 3, hence in CG cycle 7). The NE may decide based on other criteria; for example, if the UE sends a buffer status report (BSR) to transmit traffic before the CG allocation.

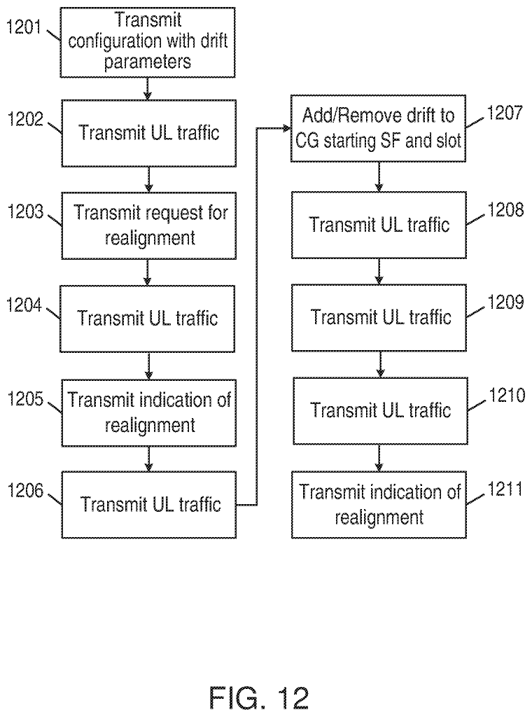

FIG. 12 illustrates an example of a flow diagram of a method that may be performed by a NE, such as NE 1310 illustrated in FIG. 13, according to various example embodiments. The realignment can be requested by a UE and implemented through a control command sent by the NE or performed directly by the UE and the NE using the new parameters communicated during the initial configuration.

In certain example embodiments, the parameters may be set as PeriodicitySyncCycle=4 (P=4), PeriodicityDrift=0.1 (|δ|=0.25), and PeriodicityDriftSign=−1 (sign(δ)=−1). These parameters may force by default to increase the starting slot by 1 every four SPS/CG cycles.

At 1201, the method may include transmitting to the UE a configuration with one or more of drift parameters PeriodicityDrift, PeriodicityDriftSign, and/or PeriodicitySyncCycle, PeriodicitySyncCycleTh, as discussed above.

At 1202, the method may include transmitting UL traffic to the NE according to currently specified CG operations (that is, transmission is performed in the granted UL CG resources).

At 1203, when the accumulated time drift exceeds the configured threshold PeriodicitySyncTh, the method may include transmitting a request for realignment to the NE (message 1).

At 1204, the method may include transmitting UL traffic to the NE according to currently specified CG operations (that is, transmission is performed in the granted UL CG resources).

At 1205, the method may include transmitting an indication of a determination of an amount of realignment (e.g., the offset) and the CG cycle to be realigned (message 2).

At 1206, the method may include transmitting UL traffic to the NE according to currently specified CG operations (that is, transmission is performed in the granted UL CG resources).

At 1207, the method may include adding or removing drift to the CG starting SF and slot.

At 1208-1210, the method may include transmitting UL traffic to the NE according to currently specified CG operations (that is, transmission is performed in the granted UL CG resources).

At 1211, the method may include transmitting an indication of a determination of an amount of realignment (e.g., the offset) and the CG cycle to be realigned (message 2).

In various example embodiments, the decision on the compensation may be decided autonomously by the NE for the realignment decision for CG cycle 7, which is signaled in CG cycle 6. The decision may be made by the NE after a number of cycles PeriodicitySyncCycle from the previous re-alignment request (in the FIG. 4 CG cycles after CG cycle 3, hence in CG cycle 7). The NE may decide based on other criteria; for example, if the UE sends a buffer status report (BSR) to transmit traffic before the CG allocation.

FIG. 13 illustrates an example of a system according to certain example embodiments. In one example embodiment, a system may include multiple devices, such as, for example, NE 1310 and/or UE 1320.

NE 1310 may be one or more of a base station, such as an eNB or gNB, a serving gateway, a server, and/or any other access node or combination thereof.

NE 1310 may further comprise at least one gNB-CU, which may be associated with at least one gNB-DU. The at least one gNB-CU and the at least one gNB-DU may be in communication via at least one F1 interface, at least one Xₙ—C interface, and/or at least one NG interface via a 5GC.

UE 1320 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1310 and/or UE 1320 may be one or more of a citizens broadband radio service device (CBSD).

NE 1310 and/or UE 1320 may include at least one processor, respectively indicated as 1311 and 1321. Processors 1311 and 1321 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1312 and 1322. The memory may be fixed or removable. The memory may include computer program instructions or computer code contained therein. Memories 1312 and 1322 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., RAM vs. ROM). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1311 and 1321, memories 1312 and 1322, and any subset thereof, may be configured to provide means corresponding to the various blocks of FIGS. 1-12. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 13, transceivers 1313 and 1323 may be provided, and one or more devices may also include at least one antenna, respectively illustrated as 1314 and 1324. The device may have many antennas, such as an array of antennas configured for multiple input multiple output (MIMO) communications, or multiple antennas for multiple RATs. Other configurations of these devices, for example, may be provided. Transceivers 1313 and 1323 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-12). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-12. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

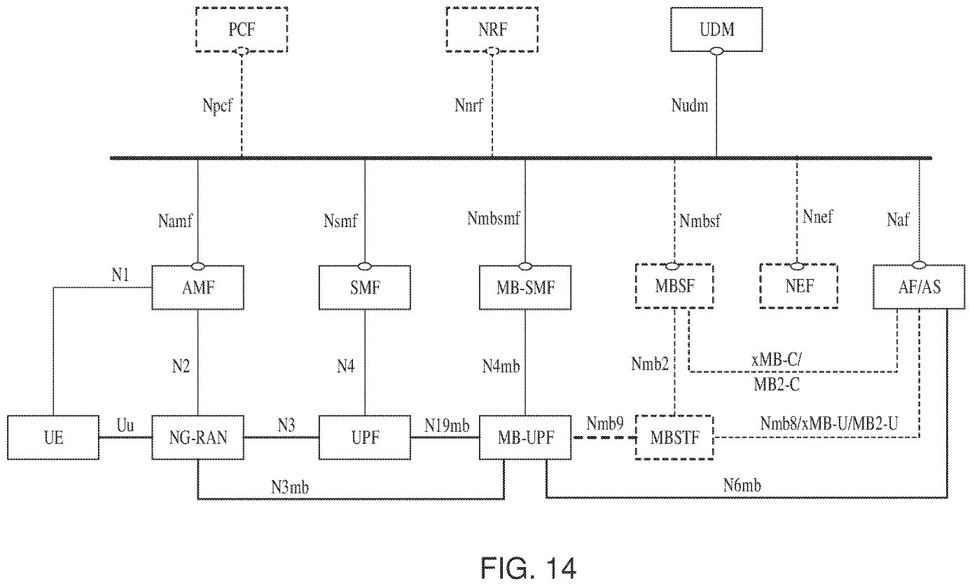

FIG. 14 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 14 may be similar to NE 1310 and UE 1320, respectively. The user plane function (UPF) may provide services such as intra-RAT and inter-RAT mobility, routing and forwarding of data packets, inspection of packets, user plane quality of service (QoS) processing, buffering of DL packets, and/or triggering of DL data notifications. The application function (AF) may primarily interface with the core network to facilitate application usage of traffic routing and interact with the policy framework.

According to certain example embodiments, processors 1311 and 1321, and memories 1312 and 1322, may be included in or may form a part of processing circuitry or control circuitry. In addition, in some example embodiments, transceivers 1313 and 1323 may be included in or may form a part of transceiving circuitry.

In some example embodiments, an apparatus (e.g., NE 1310 and/or UE 1320) may include means for performing a method, a process, or any of the variants discussed herein. Examples of the means may include one or more processors, memory, controllers, transmitters, receivers, and/or computer program code for causing the performance of the operations.

In various example embodiments, apparatus 1320 may be controlled by memory 1322 and processor 1321 to receive, from a network entity, at least one adaptive semi-persistent scheduling configuration or configured grant configuration; receive, from the network entity, an indication to trigger a semi-persistent scheduling or configured grant alignment associated with the adaptive configuration; and add or remove drift to a semi-persistent scheduling or configured grant starting subframe and slot, responsive to the indication and in accordance with the adaptive configuration.

Certain example embodiments may be directed to an apparatus that includes means for performing any of the methods described herein including, for example, means for receiving, from a network entity, at least one adaptive semi-persistent scheduling configuration or configured grant configuration; means for receiving, from the network entity, an indication to trigger a semi-persistent scheduling or configured grant alignment associated with the adaptive configuration; and means for adding or removing drift to a semi-persistent scheduling or configured grant starting subframe and slot, responsive to the indication and in accordance with the adaptive configuration.

In various example embodiments, apparatus 1310 may be controlled by memory 1312 and processor 1311 to configure a user equipment with at least one adaptive semi-persistent scheduling configuration or configured grant configuration to a user equipment; and transmit, to the user equipment, an indication to trigger a semi-persistent scheduling or configured grant alignment associated with the adaptive configuration to the user equipment.

Certain example embodiments may be directed to an apparatus that includes means for performing any of the methods described herein including, for example, means for configuring a user equipment with at least one adaptive semi-persistent scheduling configuration or configured grant configuration to a user equipment; and means for transmitting, to the user equipment, an indication to trigger a semi-persistent scheduling or configured grant alignment associated with the adaptive configuration to the user equipment.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5GS Fifth Generation System
6G Sixth Generation
AR Augmented Reality
ASIC Application Specific Integrated Circuit
BS Base Station
CBSD Citizens Broadband Radio Service Device
CG Configured Grant
CN Core Network
CPU Central Processing Unit
CS-RNTI Configured Scheduling Radio Network Temporary Identifier
DCI Downlink Control Information
DL Downlink
E2E End-to-End
eMBB Enhanced Mobile Broadband
eMTC Enhanced Machine Type Communication
eNB Evolved Node B
EPS Evolved Packet System
gNB Next Generation Node B
GPS Global Positioning System
HARQ Hybrid Automatic Repeat Request
HDD Hard Disk Drive
IE Information Element
IIoT Industrial Internet of Things
KPI Key Performance Indicator
LTE Long-Term Evolution
LTE-A Long-Term Evolution Advanced
MAC Medium Access Control
MIMO Multiple Input Multiple Output
mMTC Massive Machine Type Communication
MR Mixed Reliability
MTC Machine Type Communication
NAS Non-Access Stratum
NE Network Entity
NG Next Generation
NG-eNB Next Generation Evolved Node B
NG-RAN Next Generation Radio Access Network
NR New Radio
PDA Personal Digital Assistance
PDB Packet Delay Budget
PDCCH Physical Downlink Control Channel
PDU Protocol Data Unit
PUSCH Physical Uplink Shared Channel
QoS Quality of Service
RAM Random Access Memory
RAN Radio Access Network
RAT Radio Access Technology
RE Resource Element
RRC Radio Resource Control
RS Reference Signal
SCS Subcarrier Spacing
SDU Service Data Unit
SF Subframe
SFN System Frame Number
SMF Session Management Function
SN Sequence Number
SPS Semi-Persistent Scheduling
SRB Signaling Radio Bearer
TB Transport Block
TSC Time Sensitive Communications
Tx Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio
Access Network
VR Virtual Reality
WLAN Wireless Local Area Network
XR Extended Reality

1-15. (canceled)

16. An apparatus comprising:
at least one processor; and
at least one memory including computer program codes;
the at least one memory and the computer program codes are configured to, with the at least one processor, cause the apparatus at least to:
receive, from a network entity, at least one adaptive semi-persistent scheduling configuration or configured grant configuration;
receive, from the network entity, an indication to trigger a semi-persistent scheduling or configured grant alignment, wherein the semi-persistent scheduling or configured grant alignment is associated with the at least one adaptive semi-persistent scheduling configuration or configured grant configuration; and
add or remove a drift to a semi-persistent scheduling starting subframe and slot or configured grant starting subframe and slot, responsive to the indication and in accordance with the adaptive configuration.

17. The apparatus of claim 16, wherein the at least one received adaptive configuration comprises an indication of a sign of the drift.

18. The apparatus of claim 16, wherein the at least one received adaptive configuration comprises an indication of an absolute value of the drift.

19. The apparatus of claim 16, wherein the at least one received adaptive configuration comprises an indication of a number of semi-persistent scheduling or configured grant cycles before compensating the drift in the next semi-persistent scheduling or configured grant cycle.

20. The apparatus of claim 16, wherein the at least one received adaptive configuration comprises an indication of a threshold for a drift amount that triggers a realignment procedure.

21. The apparatus of claim 16, wherein the apparatus is further caused to:
transmit a request for realignment of the adaptive configuration to a network entity.

22. The apparatus of claim 16, wherein the apparatus is further caused to:
determine the drift is larger than the configured threshold.

23. The apparatus of claim 16, wherein the apparatus is further caused to:
determine whether a modulo operation is equal to 0.

24. The apparatus of claim 16, wherein the apparatus is further caused to:
perform realignment by adjusting the starting subframe and slot, wherein the drift is added if the sign of the drift is less than zero, and the drift is removed if the sign of the drift is greater than zero.

25. An apparatus comprising:
at least one processor; and
at least one memory including computer program codes;
the at least one memory and the computer program codes are configured to, with the at least one processor, cause the apparatus at least to:
configure a user equipment with at least one adaptive semi-persistent scheduling configuration or configured grant configuration to a user equipment; and
transmit, in response to configuring the user equipment, an indication to trigger a semi-persistent scheduling or configured grant alignment, wherein the semi-persistent scheduling or configured grant alignment is associated with the at least one adaptive semi-persistent scheduling configuration or configured grant configuration.

26. The apparatus of claim 25, wherein the at least one configured adaptive configuration comprises an indication of a sign of a drift.

27. The apparatus of claim 25, wherein the at least one configured adaptive configuration comprises an indication of an absolute value of a drift.

28. The apparatus of claim 25, wherein the at least one configured adaptive configuration comprises an indication of a number of semi-persistent scheduling or configured grant cycles before compensating a drift in the next semi-persistent scheduling or configured grant cycle.

29. The apparatus of claim 25, wherein the at least one configured adaptive configuration comprises an indication of a threshold for a drift amount that triggers a realignment procedure.

30. The apparatus of claim 25, wherein the apparatus is further caused to:
receive a request for realignment of the adaptive configuration from the user equipment.

31. A method comprising:
receiving, from a network entity, at least one adaptive semi-persistent scheduling configuration or configured grant configuration;
receiving, from the network entity, an indication to trigger a semi-persistent scheduling or configured grant alignment, wherein the semi-persistent scheduling or configured grant alignment is associated with the at least one adaptive semi-persistent scheduling configuration or configured grant configuration; and
adding or removing a drift to a semi-persistent scheduling starting subframe and slot or configured grant starting subframe and slot, responsive to the indication and in accordance with the adaptive configuration.

32. The method of claim 31, wherein the at least one received adaptive configuration comprises an indication of a sign of the drift.

33. The method of claim 31, wherein the at least one received adaptive configuration comprises an indication of an absolute value of the drift.

34. The method of claim 31, wherein the at least one received adaptive configuration comprises an indication of a number of semi-persistent scheduling or configured grant cycles before compensating the drift in the next semi-persistent scheduling or configured grant cycle.

35. The method of claim 31, wherein the at least one received adaptive configuration comprises an indication of a threshold for a drift amount that triggers a realignment procedure.
